(19) United States
(12) Patent Application Publication
(10) Pub. No.: US 2010/0182474 A1
(43) Pub. Date: Jul. 22, 2010

(54) IMAGE CAPTURE DEVICE COMPRISING PIXEL COMBINATION MEANS

(75) Inventors: Hervé Mingam, Crolles (FR); François Roy, Seyssins (FR)

Correspondence Address: STMicroelectronics Inc.;c/o WOLF, GREENFIELD & SACKS, P.C., 600 Atlantic Avenue, BOSTON, MA, 02210-2206, US

(73) Assignee: STMicroelectronics S.A., Montrouge (FR)

(21) Appl. No.: 12/690,730

(22) Filed: Jan. 20, 2010

(30) Foreign Application Priority Data
Jan. 22, 2009 (FR) 09/50376

(51) Int. Cl. H04N 5/335

(52) U.S. Cl. 348/308; 348/E05.091

(57) ABSTRACT

An image capture device includes n image sensors arranged to capture images respectively of a same scene according to at least three different colors, each of the sensors comprising a pixel array, each pixel being associated with a MOS transfer transistor, the transfer transistors of n neighboring pixels being associated with a same output; and a read circuit associated with control circuitry for reading separately, the output of each transfer transistor, or cumulatively, the outputs of from two to n neighboring transfer transistors.

### CROSS REFERENCE TO RELATED APPLICATIONS

This application claims the priority benefit of French patent application Ser. No. 09/50376, filed on Jan. 22, 2009, entitled “IMAGE CAPTURE DEVICE COMPRISING PIXEL COMBINATION MEANS,” which is hereby incorporated by reference to the maximum extent allowable by law.

### BACKGROUND OF THE INVENTION

1. Field of the Invention

The present invention relates to a device for compensating for a lack of brightness and/or of clearness of images captured by one or several color image sensors.

2. Discussion of the Related Art

Image sensors in digital image capture devices are generally formed based on a charge coupling device CCD or CMOS devices, comprising an array of pixel cells, each pixel cell comprising a photodiode for collecting electric charges and generating an output voltage according to the light that it receives.

FIG. 1A illustrates a portion of a color filter 100 for an image sensor known as a Bayer filter. Bayer filter 100 comprises a rectangular array of elementary color filters aligned with the image sensor pixels. The color filters have the function of selecting a wavelength range of the incident light and are arranged in a pattern selected so that a square group of four color filters comprises two diagonally-arranged green filters, one red filter, and one blue filter.

FIG. 1B shows an optical system comprising Bayer filter 100 of FIG. 1A, arranged on an image sensor 102 comprising a pixel cell array, each pixel cell comprising a photodiode. An image is formed on image sensor 102 by an objective lens 104. A microlens 106 is formed above each pixel cell in the array, to focus the light on an active area of the corresponding photodiode, which only takes up a determined portion of the sensor surface.

FIG. 2A shows an example of a conventional circuit for reading pixels. Each pixel comprises a photosensitive element in the form of a diode, corresponding to green, blue, red, and green light signals, G, B, R, and G, 121 to 124. Each diode is associated with a transfer transistor TR1 to TR4 having its drain terminal connected to the source terminal of a reset transistor RST having its drain connected to a supply terminal VDD. Terminal VDD is also connected to a source follower transistor SF in series with a read transistor RD and a current source I. The gate of source follower SF is connected to a node N of the drains of transfer transistors TR1 to TR4. The output read from the source of transistor RD is designated by Vout. Transistors RST, TR1 to TR4, and RD are provided to operate in switched mode and transistor SF is provided to operate as a follower (in linear state).

It should be noted that a read circuit comprising transistors RST, SF, RD, and current source I may theoretically be associated with each transfer transistor T1. These elements should then be provided for each pixel. In practice, to decrease the surface area, the assembly illustrated in FIG. 2A is generally adopted, in which each of the four G, B, R, and G diodes corresponding to four neighboring pixels G, B, R, and G (green, blue, red and green) is associated with a transfer transistor TR1 to TR4, but in which these four diodes share a same read circuit comprising transistors RST, SF, RD, and current source I. This requires a specific read program.

An example of an operating timing diagram of the circuit of FIG. 2A is illustrated in FIG. 2B. Transistor RST is initially on to precharge node N. Transistor RST is then set to the off state and read transistor RD is set to the on state, all the transfer transistors being in the off state and, at a time t1, output Vout is sampled to obtain a reference signal which takes into account the noise in the system. Then, first transfer transistor TR1 is turned on and, at a time t2, voltage Vout, which takes into account the amount of charges stored in first diode G is sampled again. This process is repeated and samplings are similarly performed at times t3, t4, t5, t6, and t7, t8 for transfer transistors TR2, TR3, and TR4. Various processing circuits, not shown, are provided to digitize signal Vout and to process the obtained signals of the various colors. Sampling times are set by a signal currently designated as CDS (correlated double sampling).

In certain cases, essentially when the image has a very low intensity for the considered pixel, the voltage on the gate of transistor SF is very close to the noise voltage and the indication given by the pixel means little since it is not very different from the noise. A solution which has been envisaged to solve this problem is to read images corresponding to pixel combinations (binning). For this purpose, it is for example attempted to cumulate corresponding signals Vout of the sets of four neighboring pixels of same color. It can be shown that, if signals Vout of n neighboring pixels are cumulated, the signal-to-noise ratio is improved by a factor n, n being equal to 4 in the example indicated hereabove. However, in practice, this requires providing relatively complex circuits to perform the combination of the voltages read for the various pixels. Further, the use of combinations of neighboring pixels is limited, since this would otherwise cause an excessive pixelization of the resulting image.

### SUMMARY OF THE INVENTION

An object of embodiments of the present invention is to provide a device which overcomes one or several disadvantages of prior art devices and which enables to improve the brightness and/or the clearness of color images.

According to an embodiment of the present invention, an image capture device comprises n (n being an integer in at least one embodiment) image sensors arranged to capture images respectively of a same scene according to at least three different colors, each of the sensors comprising a pixel array, each pixel being associated with a MOS transfer transistor, the transfer transistors of n neighboring pixels being associated with a same output; and a read circuit associated with control means for reading:
separately, the output of each transfer transistor, or
   cumulatively, the outputs of from two to n neighboring transfer transistors.

According to an embodiment of the present invention, the outputs of four transfer transistors are connected to the gate of a follower transistor.

According to an embodiment of the present invention, number n is an integral power of 2.

According to an embodiment of the present invention, each read transistor comprises, for a group of four neighboring pixels, a reset transistor connected between a supply terminal and the drains of the transfer transistors and a follower transistor in series with a read transistor and a current source connected between the supply terminal and the ground, the gate of the follower transistor being connected to the outputs of the four transfer transistors.

The foregoing objects, features, and advantages of the present invention will be discussed in detail in the following non-limiting description of specific embodiments in connection with the accompanying drawings.

### BRIEF DESCRIPTION OF THE DRAWINGS

FIG. 1A, previously described, is a top view of a Bayer filter;

FIG. 1B, previously described, schematically shows an optical system comprising the Bayer filter of FIG. 1A;

FIGS. 2A and 2B, previously described, respectively show a pixel read circuit adapted to a system with a Bayer filter and a corresponding timing diagram;

FIG. 3 is a top view of an image sensor according to an embodiment of the present invention; and

FIGS. 4A and 4B respectively show a pixel read circuit adapted to a system such as shown in FIG. 3 and a corresponding timing diagram according to an embodiment of the present invention.

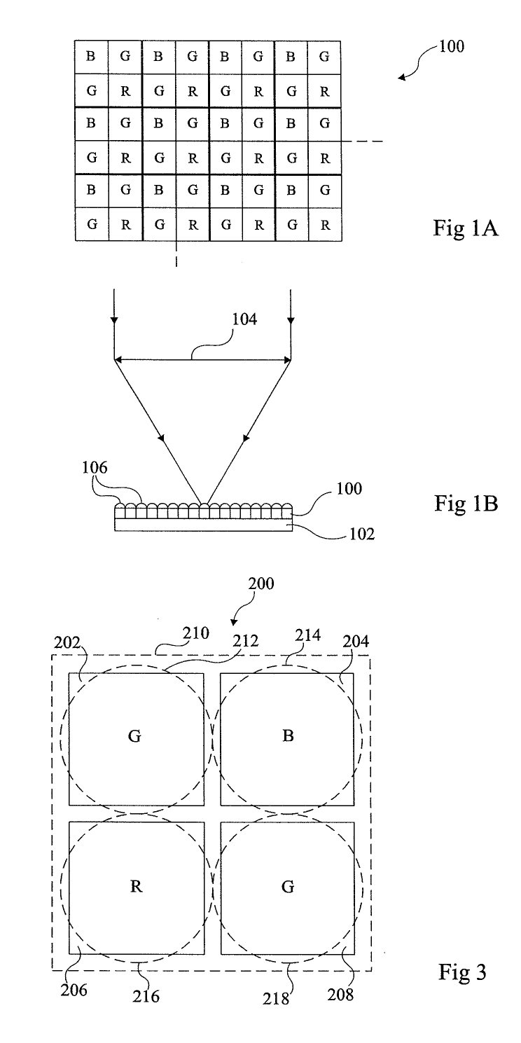

### DETAILED DESCRIPTION

FIG. 3 is a top view of an arrangement 200 of four rectangular image sensors 202, 204, 206, and 208 arranged to capture green, blue, red, and green, respectively. Each image sensor comprises a pixel cell array. A global color filter (not shown) is associated with each image sensor 202 to 208, each global color filter being of a single color and filtering the light of an entire image sensor. The images captured by sensors 202 to 208 may be combined to provide a single color image.

An arrangement of front lenses, for example, molded lenses 210, illustrated by dotted lines in FIG. 3, is installed above image sensors 202 to 208 to focus the image on each sensor. The front lens arrangement comprises objective lenses 212, 214, 216, and 218 arranged above sensors 202 to 208, respectively.

Images of a same scene are formed by objective lenses 212 to 218 on image sensors 202 to 208. The separation between the images sensors causes a very small difference due to the parallax error between the images formed on each sensor, but given that, in this example, the sensor centers are separated by 1 mm only, the difference can be considered as negligible.

Each of objective lenses 212 to 218 can be optimized for a specific color that it is in charge of transmitting, to avoid any chromatic aberration problem. This is an advantage over systems in which an objective lens must transmit all colors and must thus have a high chromatic quality. It is thus possible to obtain fine resolutions with molded lenses, that may be colored in the mass.

Generally, to form image sensors, active devices are formed in a semiconductor substrate, after which an interconnect stacking is formed on the semiconductor substrate. The light arriving on the photodiodes reaches the side of the interconnect stacking and must cross a succession of insulating layers of this stack, while the positions of the metal portions of the stack need to be selected to avoid hindering the light propagation. This is the reason why the microlenses need to have a high performance, and in particular, be perfectly aligned with respect to the underlying pixels, since they guide the light through the shadings caused by the interconnects. Accordingly, back side illumination devices (BSI) have been provided, in which the device is flipped and etched so that light reaches the photodiodes from the rear surface of the semiconductor substrate, that is, on the side opposite to the side on which the interconnect stacking is formed. In such BSI devices, it is generally not necessary to associate a microlens with each pixel.

Due to this use of four monochrome array image sensors, rather than a composite Bayer filter pixel array, it is possible to solve the problem of the gathering of the pixel images by using a simple circuit and by improving the signal-to-noise ratio of the obtained images.

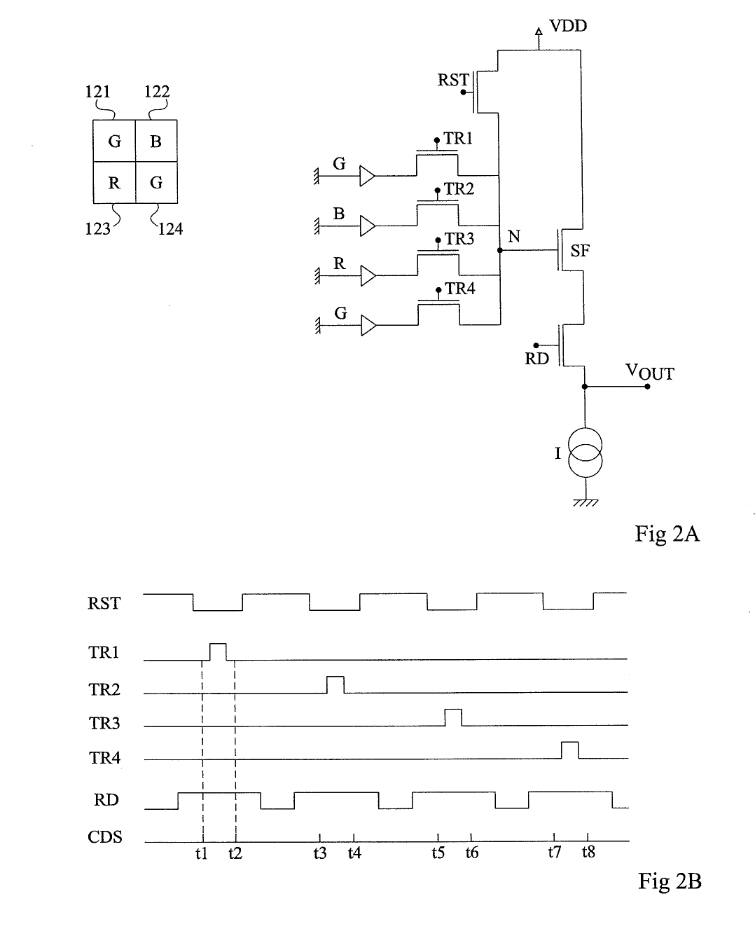

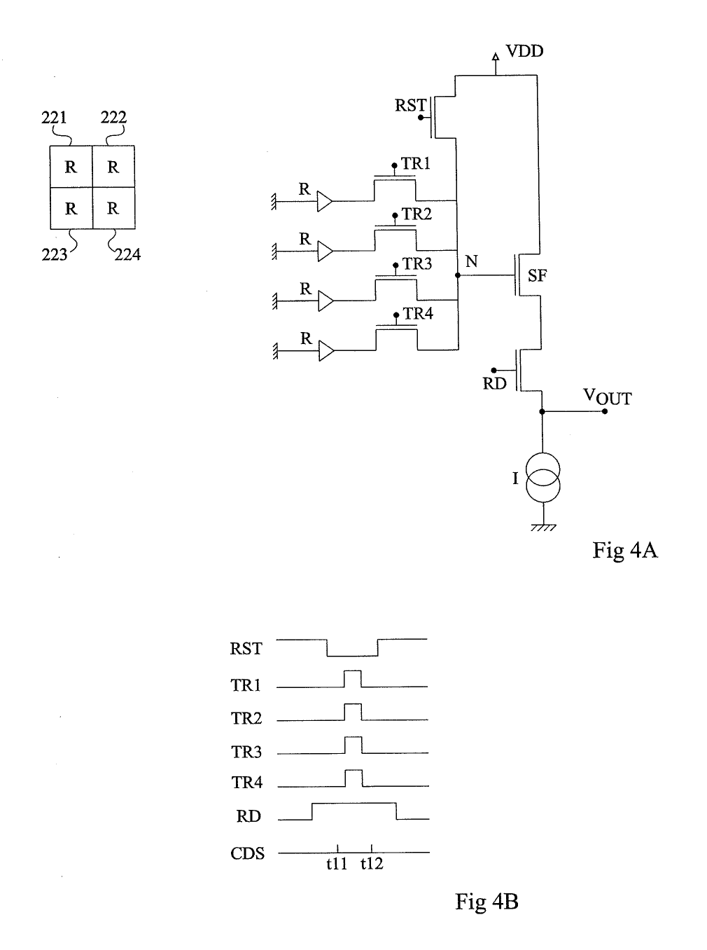

Thus, as illustrated in FIG. 4A, an embodiment of the present invention provides a circuit for analyzing the image of four neighboring pixels 221 to 224 of a same color, for example, four red pixels. This circuit is in fact identical to the prior art circuit illustrated in relation with FIG. 2A, which is a significant advantage since this does not require redesigning the circuit and the topology of the various pixels.

A read mode of the type described in relation with FIG. 2B for separately reading the charges stored in each of the diodes associated with pixels 221 to 224 may be adopted with no modification. These neighboring pixels may also be combined two by two or four by four without modifying the circuit topology.

An example of a timing diagram adapted to the combining of pixels four by four is illustrated in FIG. 4B. In this case, it is started by turning off transistor RST and turning on transistor RD, transistors TR being off. At a time t11, the charges stored on the gate of transistor SF are read to obtained a reference signal. Then, transistors TR1 to TR4 are simultaneously turned on and the charge stored on the gate of transistor SF is read at a time t12, to obtain a signal corresponding to the lighting of four pixels. Thus, the light intensities corresponding to four neighboring pixels can thus be very easily cumulated by means of the present invention. It should be noted that this time, charges present on a gate, and not output voltages, are added. This is a significant advantage. Indeed, it can be shown that, in this case, the signal-to-noise ratio increases by a factor n², if n is the number of simultaneously-processed pixels. Thus, with four simultaneously read pixels, the signal-to-noise ratio is increased by a factor 16, instead of a factor 4 in prior art, with pixel arrays using CMOS transistors.

The case of the combination of four pixels has here been described. It would also have been possible to only combine two neighboring pixels, whereby the signal-to-noise ratio would have been increased by a factor 4 (and not 2 if the obtained voltages Vout had only been added). The drains of a larger number (n) of transfer transistors could also have been interconnected, to perform measurements for any combination of between 2 and n pixels. Preferably, n will be an integral power of 2.

Although the association of the color separation according to the above principle and of the BSI technology brings in definite advantages, the present invention also applies to conventional front side illumination embodiments of arrays 202-208.

The image capture device is, for example, a mobile phone, a digital photographic camera, a portable game console, or another device comprising a digital device.

Although specific embodiments have been described, it should be clear for those skilled in the art that various alterations and modifications may be used. In particular, the case where two green filters are used has been described, since this is the most conventional configuration. However, a system with only three red, green, and blue image sensors or again with four red, green, blue, and achromatic image sensors may be selected.

It should be clear for those skilled in the art that the various features described hereabove in relation with the different embodiments and with the state of the art may be combined in any combination.

Such alterations, modifications, and improvements are intended to be part of this disclosure, and are intended to be within the spirit and the scope of the present invention. Accordingly, the foregoing description is by way of example only and is not intended to be limiting. The present invention is limited only as defined in the following claims and the equivalents thereto.

What is claimed is:

1. A color image capture device comprising:
n image sensors arranged to capture images respectively of a same scene according to at least three different colors, each of the sensors comprising a pixel array, each pixel being associated with a MOS transfer transistor, the transfer transistors of n neighboring pixels being associated with a same output; and
a read circuit associated with control means for reading:
separately, the output of each transfer transistor, or
cumulatively, the outputs of from two to n neighboring transfer transistors.

2. The image capture device of claim 1, wherein the outputs of four transfer transistors are connected to the gate of a follower transistor.

3. The image capture device of claim 1, wherein number n is an integral power of 2.

4. The image capture device of claim 1, wherein each read circuit comprises, for a group of four neighboring pixels:
a reset transistor connected between a supply terminal and the drains of the transfer transistors; and
a follower transistor in series with a read transistor and a current source connected between the supply terminal and the ground, the gate of the follower transistor being connected to the outputs of the four transfer transistors.
